(19) United States
(12) Patent Application Publication
(10) Pub. No.: US 2004/0047511 A1
(43) Pub. Date: Mar. 11, 2004

(54) Iterative compression parameter control technique for images

(75) Inventors: Alexis Tzannes, Lexington, MA (US); Ron Gut, Belmont, MA (US)

Correspondence Address: NIXON PEABODY, LLP, 401 9TH STREET, NW, SUITE 900, WASINGTON, DC, 20004-2128, US

(73) Assignee: AWARE, Inc., Bedford, MA

(21) Appl. No.: 10/611,950

(22) Filed: Jul. 3, 2003

Related U.S. Application Data
(60) Provisional application No. 60/394,820, filed on Jul. 9, 2002.

(51) Int. Cl. G06K 9/36

(52) U.S. Cl. 382/232

(57) ABSTRACT

An iterative technique for performing adapting compression parameters on one or more images is provided, where each image in a sequence of images is compressed using, for example, Part 1 of the JPEG2000 Standard. Subsequent images in the sequence of images are then processed using an adapted value of the parameter(s) determined for a previous image.

### RELATED APPLICATION DATA

This application claims the benefit of and priority under 35 U.S.C. §119(e) to U.S. patent application Ser. No. 60/394,820, filed Jul. 9, 2002, entitled “Iterative Rate Control Technique For Motion JPEG2000,” which is incorporated herein by reference in its entirety.

### BACKGROUND OF THE INVENTION

1. Field of the Invention

This invention relates to the encoding and decoding of images. In particular, an exemplary aspect of this invention relates to systems and methods for iteratively adapting compression parameters for image compression.

2. Description Of Related Art

With the dependence on multimedia technologies becoming greater exponentially, image compression techniques need to correspondingly increase in performance. The JPEG2000 standard is intended to provide rate distortion and subjective image quality performance superior to existing standards, and to also provide features and functionalities that current standards address only partially or do not address at all. The JPEG2000 standard is designed to address requirements of a diversity of applications, for example, images, internet multimedia, color facsimile, printing, color printing, scanning, digital photography, remote sensing, mobile applications, medical imagery, digital libraries, and e-commerce, just to name a few.

The JPEG2000 standard is the new image compression standard created by ISO/IEC JTC1 SC29 Working Group 1, also known as the Joint Photographic Experts Group (JPEG). Part 1 of the JPEG standard, which is incorporated herein by reference in its entirety, addresses the compression of still images. Part 3 of the JPEG standard, which is also incorporated herein by reference in its entirety, and is also referred to as Motion JPEG2000, describes a file format for JPEG2000 compressed video sequences. Each image in a sequence of images in motion JPEG20000 is compressed using the JPEG 2000 Part 1 standard.

As is common with the majority of compression standards, Part 1 of the JPEG2000 standard is a decoder standard. The standard specification addresses the syntax of the compressed code stream and the required behavior of the decoder, i.e., exactly how the decoder is to decode a compliant coded stream. Although the encoding process is implicitly dictated by the standard, not all encoding details are specified by the standard. In fact, there are several decisions and options that are left up to the encoder. A simple example is the number of wavelet transform levels, which is strictly an encoder determined option. Specifically, the number of transform levels is not dictated by the standard, only a range of allowable values, i.e., from 0 to 32, is provided.

### SUMMARY OF THE INVENTION

JPEG2000 image compression allows both lossless and lossy compression of images. Lossless compression stipulates that, after decompression, an image identical to the original image is produced. Lossy compression on the other hand, indicates that, after decompression, an image which is a representation, but not identical to, the original image is produced.

During lossy compression, distortion or data loss is introduced in the multiple steps of the compression process. The sources of this distortion include, for example, implementation precision, quantization distortion, codestream truncation, and the like.

Specifically, implementation precision introduces distortion during image processing and operations. This distortion is associated with the fact that the required arithmetic operations are not performed with infinite precision. Since some of the operands are irrational numbers they are necessarily approximated. The precision of these approximations, e.g., 32 bit or 16 bit, can directly affect the quality of the resulting image.

A second way that distortion is introduced is via quantization. Quantization is the process of mapping the calculated wavelet coefficients, which are the result of applying the wavelet transform to the original image, to a set of integer indices. The set of unique integer indices is smaller than the set of unique input wavelet coefficients. During the dequantization process, each integer index is mapped to a representative wavelet coefficient value. This introduces distortion since the representative value is an approximation of the original wavelet coefficient. After quantization, the quantized wavelet coefficients are encoded into codestreams.

A third way distortion is introduced is the truncation of these encoded codestreams. The decisions on how to truncate might be based on desired compressed image size or desired compressed image quality.

Accordingly, exemplary embodiments of the invention iteratively adapt one or more parameters that govern one or more of distortion and rate of a compressed image or sequence of images, individually or as a whole. These parameters include, for example, but are not limited to, quantization parameters, which may include binwidths or other quantization decisions, and truncation parameters, which may include specific truncation points or other truncation decisions.

Thus, as a specific example, the exemplary systems and methods discussed herein at least address an iterative technique for performing rate allocation on video sequences, where each image is compressed using Part 1 of the JPEG2000 Standard. However, it should be appreciated that in general any compression parameter can be adapted based on the general techniques discussed herein. Furthermore, the techniques disclosed herein can be expanded to any type or format of image or image sequence. Additionally, the techniques disclosed herein can be applied to the compression of time-series data, such as video sequences, as well as other 3 dimensional data sets, such as medical data, such as, CAT or MRI scans, which are 2 dimensional slices cut along a volume, and hyperspectral data, which are 2 dimensional images differing by the acquisition spectral band, i.e., their color.

In particular, the exemplary technique disclosed hereinafter at least provides greater computational efficiency because the rate control calculations only need be performed on a subset of images in a sequence of images. Subsequent images in the sequence of images are processed using an adapted value of the parameter(s) that were determined for the previous image.

Additionally, the exemplary systems and methods discussed herein provide a technique for compressing a video sequence using Motion JPEG2000, where, for example, a rate control algorithm is applied to each image in a sequence of images.

The rate control algorithm can be used to control the file size or the quality of the compressed images. In accordance with this technique, the rate control technique can be performed using very few computations for each image in the sequence. Furthermore, the technique can be used for controlling the bit rate for the entire sequence as a whole. In addition, the technique can be used for controlling the quality of the entire sequence as a whole. Accordingly, the exemplary systems and methods of this invention at least provide a technique for controlling one or more compression parameters for a series of images and/or an image sequence.

Aspects of the invention also relate to iteratively controlling one or more compression parameter values for a plurality of images in an image sequence.

Aspects of the invention also relate to iteratively controlling one or more compression global parameter values for a plurality of images in an image sequence.

Aspects of the invention further relate to an iterative rate control system for images.

Aspects of the invention further relate to an iterative distortion control system for images.

Aspects of the invention also relate to using an adapted compression parameter to compress subsequent images in an image sequence.

Aspects of the invention further relate to an iterative rate control system for compressing video sequences that adapts the value of the slope of the rate distortion curve from one frame to the next frame in the sequence.

Aspects of the invention further relate to an iterative rate control system where the value of the slope of the rate distortion curve is estimated based on the assumption that the quantized wavelet coefficients follow a statistical distribution.

Aspects of the invention further relate to an iterative rate control system where the value of the slope of the rate distortion curve is estimated based on the assumption that the quantized wavelet coefficients follow a generalized Gaussian distribution.

Aspects of the invention additionally relate to an iterative rate control system where the value of the slope of the rate distortion curve is estimated based on the assumption that the quantized wavelet coefficients follow a Laplacian distribution.

A further aspect of the invention relates to an iterative rate control system where the value of the slope of the rate distortion curve is determined by computing the actual rates after compressing the quantized wavelet coefficients.

Aspects of the invention further relate to an iterative rate control system where the value of the slope of the rate distortion curve is adapted based on the assumption that the slope of the rate distortion curve and the resulting total rate follow a functional relationship.

Theses and other features and advantages of this invention are described in, or are apparent from, the following detailed description of the embodiments.

### BRIEF DESCRIPTION OF THE DRAWINGS

The embodiments of this invention will be described in detail, with reference to the following figures, wherein:

FIG. 1 illustrates an exemplary compression system according to this invention;

FIG. 2 is a flowchart illustrating an exemplary compression method according to this invention;

FIG. 3 is a functional block diagram illustrating a second exemplary compression system according to this invention;

FIGS. 4-6 are plots illustrating the performance of the exemplary techniques according to this invention; and

FIG. 7 is a flowchart illustrating a second exemplary compression method according to this invention.

### DETAILED DESCRIPTION OF THE INVENTION

The exemplary systems and methods of this invention will be described in relation to image encoding and image decoding. However, to avoid unnecessarily obscuring the present invention, the following description omits well-known structures and devices that may be shown in block diagram form or otherwise summarized. For the purposes of explanation, numerous specific details are set forth in order to provide a thorough understanding of the present invention. It should however be appreciated that the present invention may be practiced in a variety of ways beyond the specific details set forth herein.

Furthermore, while the exemplary embodiment illustrated herein show the various components of the system collocated, it is to be appreciated that the various components of this system can be located at distant portions of a distributed network, such as a LAN and/or the internet, or within a dedicated image processing system. Thus, it should be appreciated that the components of the image processing system can be combined into one or more devices or collocated on a particular node of a distributed network, such as a communications network. It will be appreciated from the following description, and for reasons of computational efficiency, that the components of the image processing system can be arranged at any location within a distributed network without affecting the operation of the system.

Furthermore, it should be appreciated that the various links connecting the elements can be wired or wireless links, or any combination thereof, or any other known or later developed element(s) that is capable of supplying and/or communicating data to and from the connected elements. Additionally, the term module as used herein can refer to any known or later developed hardware, software, or combination of hardware and software that is capable of performing the functionality associated with that element.

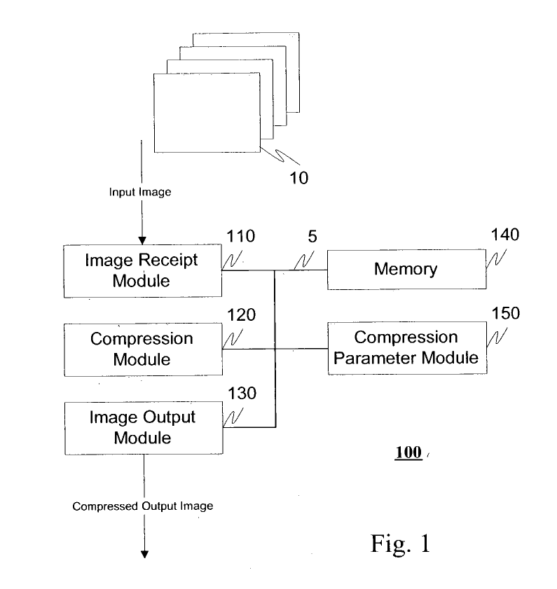

FIG. 1 illustrates an exemplary image compression system 100. The image compression system 100 comprises an image receipt module 110, a compression module 120, an image output module 130, a memory 140 and a compression parameter module 150, all interconnected by links 5. In operation, the image receipt module 110 receives a first image 10. The first image 10 can be independent or in a sequence of images. Next, and in cooperation with the compression module 120 and the memory 140, the first image is compressed. The parameters used for the compression by the compression module 120 are then stored in the compression parameter module 150. The compressed first image is then output via the image output module 130.

In preparation for compression of the second image in a sequence of images, the value of the one or more stored compression parameter(s) are adapted based on, for example, a metric. These parameters control, for example, the distortion or file size in the compressed image. These parameters can include, but are not limited to, quantization parameters, which may include binwidths or other quantization decisions, and truncation parameters, which may include specific truncation points or other truncation decisions. Implementation precision generally tends to be fixed by various architectures, systems, and implementation choices.

The metric, in general, relates to iterative technique, in that it can be used to control the quality, size, or the like, of the compressed images or sequence of images. If, for example, size is the target metric, an aim would be to introduce the least possible distortion while maintaining a target image size for each image or sequence. If, for example, quality is the target metric, a aim is to produce the smallest possible image size while maintaining a target quality for each image or sequence. Thus, for example, for image quality either or both of objective image quality metrics, such as the peak signal to noise ratio (pSNR), mean squared error (MSE), or the like, or subjective metrics, e.g., based on human visual system models or operator inspection, can be used. For image size, for example, bitrate, compression ratio, and file size can be controlling metrics.

Having the adapted value of the one or more compression parameters, the adapted value, in conjunction with the compression parameter module 150, memory 140 and compression module 120, compresses the next images in the sequence of images. The adapted compression parameters are then stored in the compression parameter module 150 and the compressed image output via the image output module 130, in cooperation with the memory 140 and a controller (not shown). This sequence of operations continues until all or a predetermined number of images have been compressed and output.

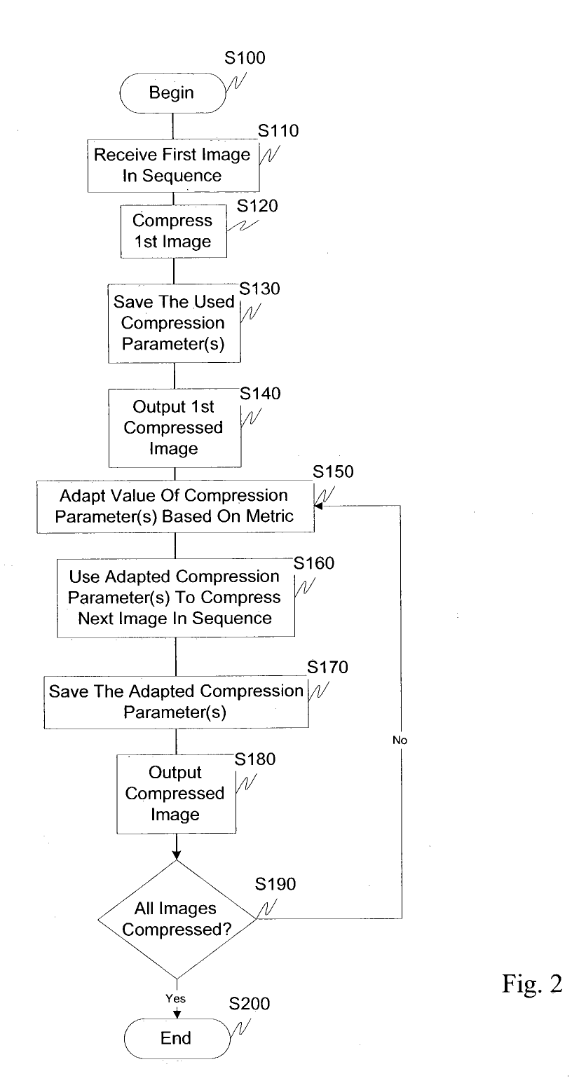

FIG. 2 outlines an exemplary method of performing image compression based on an adapted value of a compression parameter(s) according to this invention. In particular, control beings on step S100 and continues to step S110. In step S110, the first image in a sequence of images is received. Next, in step S120, the first image is compressed, using a compression algorithm such as JPEG, JPEG2000, or the like. Then, in step S130, the compression parameter(s) used for compressing the first image are stored. Control then continues to step S140.

In step S140, the first compressed image is output. Next, in step S150, the value of the compression parameter(s) that were used on the first image are adapted based on, for example, a metric, as discussed above. Next, in step S160, the adapted compression parameter(s) are used to compress the next image in the sequence. Then, in step S170, the adapted compression parameter(s) are stored. Control then continues to step S180.

In step S180, the compressed image is output. Next, in step S190, a determination is made whether all images have been compressed. If all images have been compressed, control continues to step S200 where the control sequence ends Otherwise, control jumps back to step S150.

As discussed above, and in general, the techniques illustrated herein address controlling one or more compression parameters for an image, a series of images and/or an image sequence. To specifically illustrate an exemplary application of these general techniques, the following sections will discuss the underlying theory of optimal rate allocation of compressed images, including a description of a technique directly applicable to JPEG2000 based on Laplacian distributions.

Specifically, consider an image that has been decomposed into N subbands using a 2-dimensional wavelet transform. Each subband is denoted as Sᵢ, i=1, . . . , N. Quantizing each subband Sᵢ to a rate Rᵢ result in some amount of distortion on the final reconstructed image. This distortion will be denoted as Dᵢ(Rᵢ). Assuming that the distortion measure is additive across all subbands, the total distortion on the final image will be:

$${D}_{total} = {\sum }_{i = 1}^{N} {n}_{i} {N}_{i} {D}_{i} ( {R}_{i} ) , \qquad ( 1 )$$

where nᵢ is the fraction of coefficients in subband i, and Nᵢ is a normalization factor that accounts for the wavelet transform synthesis gain.

The total achieved encoding rate over all subbands is:

$$R = {\sum }_{i = 1}^{N} {n}_{i} {R}_{i} . \qquad ( 2 )$$

The exemplary optimal rate allocation technique attempts to minimize the distortion Dₜₒₜₐₗ subject to the constraint that the total achieved rate, R, satisfies the condition R≦R_{target}, where R_{target} is a desired rate. This constraint minimization problem can be solved using the method of Lagrangian Multipliers. Using this technique, the problem is equivalent to minimizing the Lagrangian function J, given by:

$$J = {\sum }_{i = 1}^{N} {n}_{i} {N}_{i} {D}_{i} ( {R}_{i} ) - λ {\sum }_{i = 1}^{N} {n}_{i} {R}_{i} , \qquad ( 3 )$$

where λ is the Lagrangian Multiplier. Differentiating J with respect to Rᵢ and setting equal to 0 leads to the following expression for λ:

$$λ = {N}_{i} {D}_{i}^{′} ( {R}_{i} ) , f o r i = 1 , … , N , \qquad ( 4 )$$

where

$${D}_{i}^{′} ( {R}_{i} )$$

is the derivative of the distortion Dᵢ(Rᵢ) for subband Sᵢ evaluated at the specific rate Rᵢ.

The value of λ is approximately the slope of the rate distortion curve at Rᵢ. Therefore, determining the optimal rate allocation can be considered equivalent to estimating or approximating the rate distortion curve for each subband, and selecting a point on the curve that equals a specific λ. There are several exemplary methods of estimating or approximating the rate distortion curve.

A common technique for estimating the rate distortion curve is to assume a statistical model for the quantized wavelet coefficients, and derive the rate distortion relationship based on this assumption. In this approach, both the rate and distortion values are estimated before the data is encoded. Quantization binwidths are selected based on these estimates and the quantized coefficients are encoded without any truncation. However, the rate control accuracy of this approach is heavily dependent on the data following the assumed statistical model.

In this exemplary embodiment, we assumed that the quantized wavelet coefficients can be modeled using a Laplacian density. Under this assumption, the rate distortion curve can be approximated by simply calculating the variance of each subband. However, it should be appreciated that while Laplacian modeling was used for this exemplary embodiment, in general Generalized Gaussians or any other statistical model could be used.

The rate control accuracy of this approach is heavily dependent on the data following the assumed Laplacian model. In practice, this approach may result in compressed image files that deviate 10-20% from the target size.

In particular, in accordance with this exemplary embodiment, the technique comprises compressing the first image in a sequence of images using the rate distortion theory described above, assuming that the quantized wavelet coefficients follow a Laplacian distribution, and saving the value of the Lagrangian Multiplier that was used. The value of the Lagrangian Multiplier is then adapted based on, for example, the difference between a target rate for the current image undergoing processing and an achieved rate for one or more prior images that have been compressed. The value of the Lagrangian Multiplier could also be adapted based on the difference between a target image quality for the current image being processed and the achieved quality for one or more prior image(s) that have been compressed. The adapted Lagrangian Multiplier is then utilized to select binwidths and to compress a next image in the sequence of images. The new adapted Lagrangian Multiplier is then saved and the next image in the sequence of images is processed.

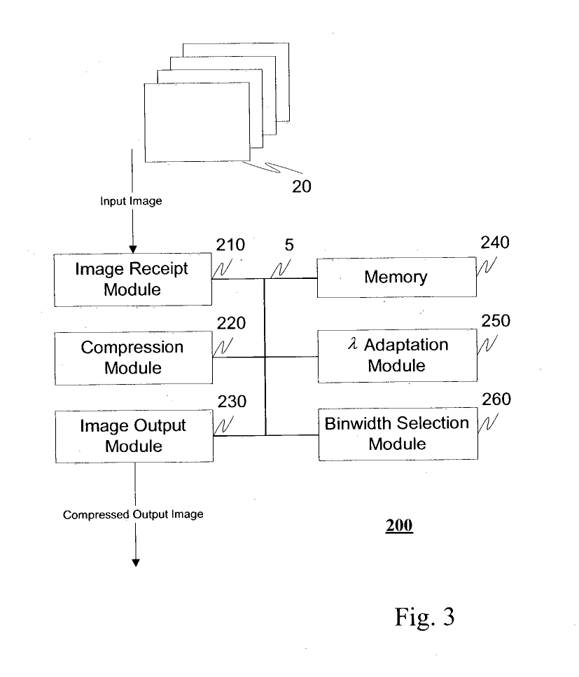

More specifically, and in relation to FIG. 3, an image compression system 200 is illustrated. The image compression system 200 comprises an image receipt module 210, a compression module 220, and image output module 230, a memory 240, a Lagrangian Multiplier adaptation module 250 and a binwidth selection module 260, all interconnected by links 5.

In operation, a first image 20 in a sequence of images is received via the image receipt module 210. In cooperation with the compression module 220 and the memory 240, the first image in the sequence of images is compressed and the used value of the Lagrangian Multiplier stored with the cooperation of the memory 240 in the Lagrangian Multiplier adaptation module 250. The first compressed image is then output via the image output module 230.

The value of the Lagrangian Multiplier is then adapted based on a difference between a target rate and an achieved rate for the current image with the cooperation of the Lagrangian Multiplier adaptation module 250 and memory 240. However, as discussed above, the Lagrangian Multiplier could also be adapted based on a difference between a target quality and an achieved quality, or combination thereof, for the current image. This adapted Lagrangian Multiplier is then used to select binwidths and compress the next image in the sequence by the compression module 220, with the cooperation of the image receipt module 210, the binwidth selection module 260 and the memory 240. The adapted Lagrangian Multiplier is then stored in the Lagrangian Multiplier adaptation module 250 and a determination made whether all images in the sequences of images have been compressed. If all images have been compressed, the processing is done. However, if additional images exist, the process continues until all images, or a predetermined number of images, have been compressed.

An important aspect of this technique is the adaptation step where the Lagrangian Multiplier is adapted based on the difference between at least one of the target rate and an achieved rate, and the target quality and an achieved quality. The functional relationship between the Lagrangian Multiplier and Rₜₒₜₐₗ must be understood to arrive at a proper technique to adapt the Lagrangian Multiplier.

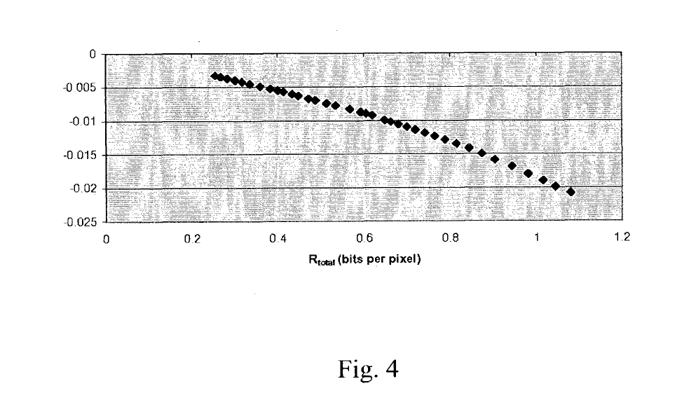

FIG. 4 illustrates the relationship between the Lagrangian Multiplier (λ) and the achieved Rₜₒₜₐₗ, for an exemplary single image, compressed using the Laplacian modeling technique discussed above at a plurality of different compression ratios. This exemplary relationship is specific to the data being processed and the exact exemplary setup that was used. Thus, it should be fully appreciated that this exemplary relationship is merely illustrative and does not limit the scope of this invention.

For this exemplary single image, note that the relationship between the Lagrangian Multiplier and Rₜₒₜₐₗ is approximately linear, and by plotting the same curve for a plurality of images, comparable results can be achieved.

Furthermore, it can be illustrated that for an Independent Identically Distributed sequence quantized using a Scalar Quantizer, as is used in JPEG2000, the relationship between the Lagrangian Multiplier and Rₜₒₜₐₗ is very close to being linear, especially at higher bit rates. Given the approximately linear relationship between the Lagrangian Multiplier and Rₜₒₜₐₗ, the following adaptive procedure can be used to modify the Lagrangian Multiplier from frame to frame within the sequence.

Specifically, the first image is compressed and R_{achieved} designated as the compressed image size and R_{target} designated as the target compressed image size. The rate control error can then be determined in accordance with:

$${RC}_{error} = \frac{{R}_{achieved} - {R}_{target}}{{R}_{target}} . \qquad ( 5 )$$

Of course, a comparable equation can be written for the quality control error.

Then, the value of the Lagrangian Multiplier is adapted based a percent based on this error in accordance with:

λ_{new}=λₚᵣₑᵥᵢₒᵤₛ*ƒ(RCₑᵣᵣₒᵣ), (6)

where ƒ is a function representing quality or rate difference that approximates the relationship between the Lagrangian Multiplier and Rₜₒₜₐₗ. The next image in the sequence is then compressed using λ_{new}, at which time the process continues back to determining the next rate control or quality control error.

Having experimented with different functions to arrive at the best approximation, the function ƒ was initially estimated by fitting a line to a curve similar to the one illustrated in FIG. 4, which was calculated for a single image in the sequence. This technique works well for a sequence of similar images. However, once the images change significantly, as may happen when the scene changes in a video sequence, the estimate becomes less accurate, causing the rate control to be less accurate.

To compensate for this affect, another approach could be to update the estimate of ƒ every N frames in the sequence.

The performance of the above exemplary iterative rate control procedure was analyzed on real video sequences, by analyzing the quality of the compressed images and the rate control accuracy. However, it should be appreciated that performance figures will vary based on, for example, the data being processed and the exact configuration, and the following performance figures are to be considered merely illustrative and the techniques of this invention not limited thereto.

In particular, the exemplary embodiments discussed above was applied to a series of exemplary video images. All of the results discussed below were determined by compressing high action video sequences. These sequences are difficult to compress as they have a large amount of detail in the scene and frequent scene changes. In particular, the exemplary performance was analyzed based on a comparison between the resulting compressed image quality and rate control accuracy.

Specifically, the exemplary results presented below were created by compressing a 2 minute 25 second video sequence. Each image in the 30 frames/second sequence was 320 by 240 pixels, 3 channel, 24 bit color. The original uncompressed sequence comprised 4,303 images, for a total of 945 MBytes, which is equivalent to a data rate of 6.59 MBytes/sec. This sequence will be referred to below as Sequence #1. The exemplary results presented in the following sections for Sequence #1 are representative of the results for all the sequences tested.

Analyzing the rate control accuracy of the proposed iterative approach, Sequence #1 was compressed using the proposed iterative rate control procedure at target compression ratios ranging from 10 to 1 to 80 to 1. The rate control accuracy results are presented below in Table 1. Note that the achieved compression ratio, or bitrate, is within 1% of the target rate for all cases.

TABLE 1
Rate control accuracy: Results of compressing Sequence #1
at different compression ratios.

| Target | | | |
|---|---|---|---|
| Compression | Target Bitrate | Achieved | Achieved Bitrate |
| Ratio | (KBytes/sec) | Compression Ratio | (KBytes/sec) |
| 10 | 675.0 | 10.0 | 675.0 |
| 15 | 450.0 | 15.1 | 447.0 |
| 20 | 227.5 | 20.1 | 335.8 |
| 25 | 270.0 | 25.2 | 267.9 |
| 30 | 225.0 | 30.3 | 222.8 |
| 40 | 168.8 | 40.4 | 167.1 |
| 50 | 135.0 | 50.5 | 133.7 |
| 60 | 112.5 | 60.6 | 111.4 |
| 70 | 96.4 | 70.7 | 95.5 |
| 80 | 84.4 | 80.8 | 83.5 |

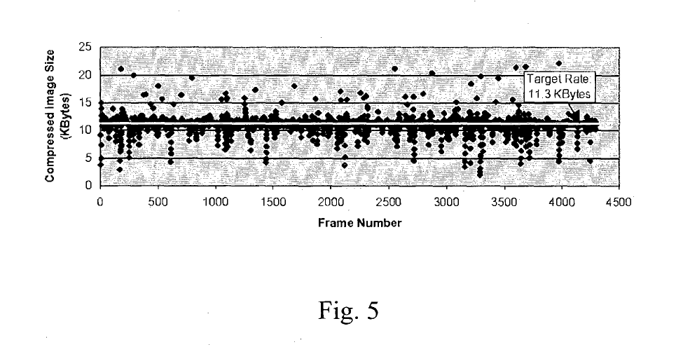

For additional insight, FIG. 5 compares the achieved compressed image size for all 4,303 images in the sequence, for the 20 to 1 compression ratio case. The target rate for each image is 11.3 KBytes. Note that the rate control technique was fairly accurate, but deviates from this target rate on certain images. This is usually caused by a change in the scene within the sequence. In the cases where the scene changes from a relatively simple scene to a more complicated scene that is more difficult to compress, the resulting compressed image size could jump above the target rate. Conversely, in cases where the scene changes to a simpler scene, the image size falls below the target rate. Note however that the adaptive nature of the algorithm woks well and the compressed image size converges quickly back to the desired size. As a result, the overall compressed sequence size is very close to the desired target size, as illustrated in Table 1.

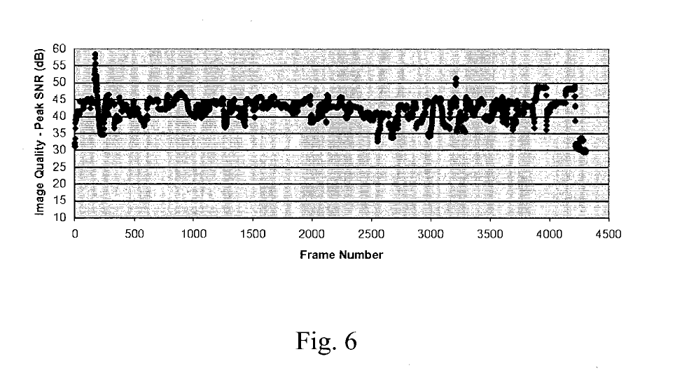

In relation to the image quality, the exemplary sequences were compressed at 20 to 1 as described in the previous section and each image in the sequence was then decompressed and compared to the corresponding original image in the sequence. FIG. 6 illustrates the exemplary resulting pSNR of each of the 4,303 images in the sequence. The pSNR values shown are actually the average of the pSNRs for the three color channels. Note that the quality was consistently high, usually above 35 dB. The average pSNR for this compressed sequence is 42.3 dB.

The exemplary embodiment discussed herein address a computationally efficient iterative rate control procedure for compressing video sequences using JPEG2000. The proposed technique is targeted, for example, at applications where real-time or near real-time encoding of the video sequence is necessary, however is not limited thereto and can be applied to any image, image type or video sequence. An exemplary aspect of the general technique provides accurate rate control for an image sequence as a whole.

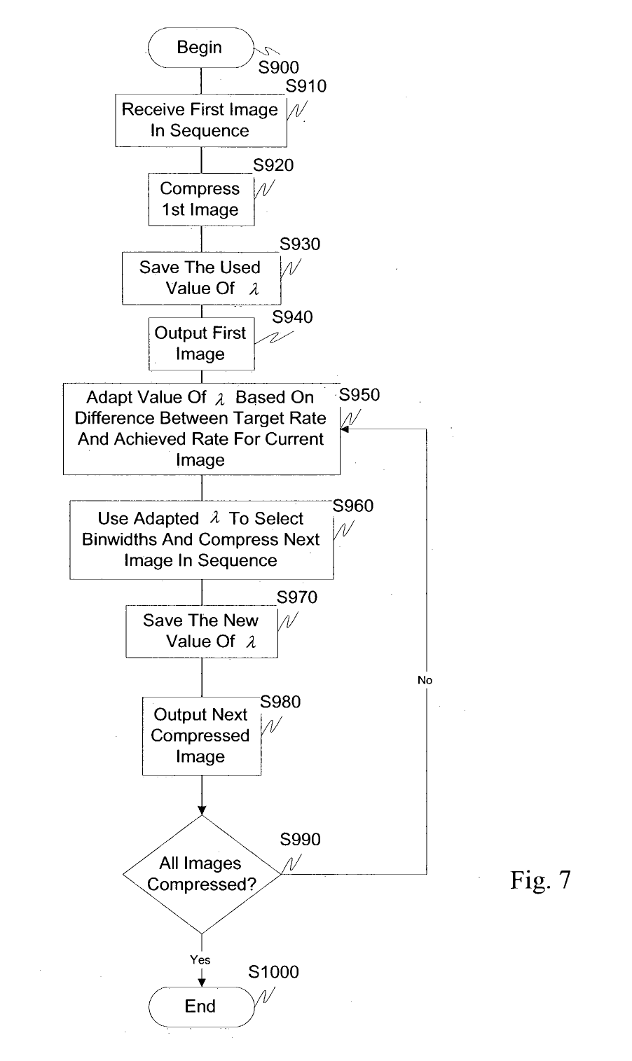

FIG. 7 illustrates an exemplary method of compressing images in a sequence using rate distortion optimization by data modeling based on Laplacian distributions. In particular, control beings in step S900 and continues to step S910. In step S910, a first image in a sequence of images is received. Next, in step S920, the first image is compressed. Then, in step S930, the used value of the Lagrangian Multiplier is stored. Control then continues to step S940.

In step S940, the first compressed image is output. Next, in step S950, the value of the Lagrangian Multiplier is adapted based on a difference between a target rate or target quality and the achieved rate for the current image. Then, in step S960, this adapted Lagrangian Multiplier value is used to select the binwidths and compress the next image in the sequence of images. Control then continues to step S970.

In step S970, the adapted value of the Lagrangian Multiplier is saved. Next, in step S980, the compressed image is output and control continues to step S990. Then, in step S990, a determination is made whether all images have been compressed. If all images have been compressed, control continues to step S1000 where the control sequence ends. Otherwise, control jumps back to step S950.

The above-described systems and methods can be implemented on an image processing device, an encoding/decoding device, or the like, or on a separate programmed general purpose computer having image processing capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like. In general, any device capable of implementing a state machine that is in turn capable of implementing the flowcharts illustrated herein can be used to implement the image processing system according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and data encoding/decoding arts.

Moreover, the disclosed methods may be readily implemented in software executed on programmed general purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a dedicated encoding/decoding system, as a plug-in, or the like. The system can also be implemented by physically incorporating the system and method into a software and/or hardware system, such as the hardware and software systems of an image processor.

It is, therefore, apparent that there has been provided, in accordance with the present invention, systems and methods for iterative coding. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. An image compression system comprising:
a compression module that receives a first image in a sequence of images and compresses the image at least based on one or more parameters; and
a compression parameter module, the compression parameter module adapting the one or more parameters used on the first image for compression of a next image.

2. The system of claim 1, wherein the next image is compressed using the one or more adapted parameters.

3. The system of claim 1, wherein the compression parameter module adapts the one or more parameters based on a metric.

4. The system of claim 3, wherein the metric is at least based on one of image file size and image quality.

5. The system of claim 4, wherein the metric governing image quality is based on one or more of peak signal to noise ratio, mean squared error, human visual system models and operator inspection.

6. The system of claim 4, wherein the metric governing image file size is based on one or more of bitrate, compression ratio, and byte count.

7. The system of claim 3, wherein the metric is based on a difference between a target image file size and an achieved image file size.

8. The system of claim 3, wherein the metric is based on a difference between a target image quality and an achieved image quality.

9. The system of claim 1, wherein the one or more parameters are one or more of quantization parameters and truncation parameters.

10. The system of claim 9, wherein the quantization parameters are one or more of binwidths and quantization decisions.

11. The system of claim 9, wherein the truncation parameters are one or more of specific truncation points and truncation decisions.

12. The system of claim 1, wherein the image compression system is adapted to compress one or more of a sequence of images, time-series data, and 3-dimensional data sets.

13. The system of claim 1, wherein the compression parameter module iteratively controls the one or more parameters.

14. The system of claim 1, wherein the compression parameter module iteratively and dynamically controls the one or more parameters.

15. The system of claim 1, further comprising a binwidth selection module.

16. The system of claim 1, further comprising a truncation selection module.

17. The system of claim 1, further comprising a quantization selection module.

18. An image compression system comprising:
a compression module that receives n images and compresses the n images at least based on one or more parameters; and
a compression parameter module, the compression parameter module adapting the one or more parameters used on the n images, for use in compressing x images.

19. An image compression method comprising:
receiving a first image in a sequence of images and compressing the image at least based on one or more parameters; and
adapting the one or more parameters used on the first image for compression of a next image.

20. The method of claim 19, wherein the next image is compressed using the one or more adapted parameters.

21. The method of claim 19, wherein the compression parameter module adapts the one or more parameters based on a metric.

22. The method of claim 21, wherein the metric is at least based on one of image file size and image quality.

23. The method of claim 22, wherein the metric governing image quality is based on one or more of peak signal to noise ratio, mean squared error, human visual system models and operator inspection.

24. The method of claim 22, wherein the metric governing image file size is based on one or more of bitrate, compression ratio, and byte count.

25. The method of claim 21, wherein the metric is based on a difference between a target image file size and an achieved image file size.

26. The method of claim 21, wherein the metric is based on a difference between a target image quality and an achieved image quality.

27. The method of claim 19, wherein the one or more parameters are one or more of quantization parameters and truncation parameters.

28. The method of claim 27, wherein the quantization parameters are one or more of binwidths and quantization decisions.

29. The method of claim 27, wherein the truncation parameters are one or more of specific truncation points and truncation decisions.

30. The method of claim 19, wherein the first image and the next image are one or more of a sequence of images, time-series data, and 3-dimensional data sets.

31. The method of claim 19, further comprising iteratively controlling the one or more parameters.

32. The method of claim 19, further comprising iteratively and dynamically controlling the one or more parameters.

33. The method of claim 19, further comprising selecting a binwidth.

34. The method of claim 19, further comprising selecting a truncation.

35. The method of claim 19, further comprising selecting a quantization.

36. An image compression method comprising:
receiving n images and compressing the n images at least based on one or more parameters; and
adapting the one or more parameters used on the n images, for use in compressing x images.

37. An image compression system comprising:
means for receiving a first image in a sequence of images and compressing the image at least based on one or more parameters; and
means for adapting the one or more parameters used on the first image for compression of a next image.

38. The system of claim 37, wherein the next image is compressed using the one or more adapted parameters.

39. The system of claim 37, wherein the means for adapting adapts the one or more parameters based on a metric.

40. The system of claim 39, wherein the metric is at least based on one of image file size and image quality.

41. The system of claim 40, wherein the metric governing image quality is based on one or more of peak signal to noise ratio, mean squared error, human visual system models and operator inspection.

42. The system of claim 40, wherein the metric governing image file size is based on one or more of bitrate, compression ratio, and byte count.

43. The system of claim 39, wherein the metric is based on a difference between a target image file size and an achieved image file size.

44. The system of claim 39, wherein the metric is based on a difference between a target image quality and an achieved image quality.

45. The system of claim 37, wherein the one or more parameters are one or more of quantization parameters and truncation parameters.

46. The system of claim 45, wherein the quantization parameters are one or more of binwidths and quantization decisions.

47. The system of claim 45, wherein the truncation parameters are one or more of specific truncation points and truncation decisions.

48. The system of claim 37, wherein the first image and the next image are one or more of a sequence of images, time-series data, and 3-dimensional data sets.

49. The system of claim 37, further comprising iteratively controlling the one or more parameters.

50. The system of claim 37, further comprising iteratively and dynamically controlling the one or more parameters.

51. The system of claim 37, further comprising means for selecting a binwidth.

52. The system of claim 37, further comprising means for selecting a truncation.

53. The system of claim 37, further comprising means for selecting a quantization.

54. An image compression system comprising:
means for receiving n images and compressing the n images at least based on one or more parameters; and
means for adapting the one or more parameters used on the n images, for use in compressing x images.

55. An image compression protocol comprising:
receiving a first image in a sequence of images and compressing the image at least based on one or more parameters; and
adapting the one or more parameters used on the first image for compression of a next image.

56. The protocol of claim 55, wherein the next image is compressed using the one or more adapted parameters.

57. The protocol of claim 55, wherein the compression parameter module adapts the one or more parameters based on a metric.

58. The protocol of claim 57, wherein the metric is at least based on one of image file size and image quality.

59. The protocol of claim 58, wherein the metric governing image quality is based on one or more of peak signal to noise ratio, mean squared error, human visual system models and operator inspection.

60. The protocol of claim 58, wherein the metric governing image file size is based on one or more of bitrate, compression ratio, and byte count.

61. The protocol of claim 57, wherein the metric is based on a difference between a target image file size and an achieved image file size.

62. The protocol of claim 57, wherein the metric is based on a difference between a target image quality and an achieved image quality.

63. The protocol of claim 55, wherein the one or more parameters are one or more of quantization parameters and truncation parameters.

64. The protocol of claim 63, wherein the quantization parameters are one or more of binwidths and quantization decisions.

65. The protocol of claim 63, wherein the truncation parameters are one or more of specific truncation points and truncation decisions.

66. The protocol of claim 55, wherein the first image and the next image are one or more of a sequence of images, time-series data, and 3-dimensional data sets.

67. The protocol of claim 55, further comprising iteratively controlling the one or more parameters.

68. The protocol of claim 55, further comprising iteratively and dynamically controlling the one or more parameters.

69. The protocol of claim 55, further comprising selecting a binwidth.

70. The protocol of claim 55, further comprising selecting a truncation.

71. The protocol of claim 55, further comprising selecting a quantization.

72. An image compression protocol comprising:
receiving n images and compressing the n images at least based on one or more parameters; and
adapting the one or more parameters used on the n images, for use in compressing x images.

73. An information storage media comprising information that compresses images comprising:
information that receives a first image in a sequence of images and compresses the image at least based on one or more parameters; and
information that adapts the one or more parameters used on the first image for compression of a next image.

74. The media of claim 73, wherein the next image is compressed using the one or more adapted parameters.

75. The media of claim 73, wherein the information that compresses adapts the one or more parameters based on a metric.

76. The media of claim 75, wherein the metric is at least based on one of image file size and image quality.

77. The media of claim 76, wherein the metric governing image quality is based on one or more of peak signal to noise ratio, mean squared error, human visual system models and operator inspection.

78. The media of claim 76, wherein the metric governing image file size is based on one or more of bitrate, compression ratio, and byte count.

79. The media of claim 75, wherein the metric is based on a difference between a target image file size and an achieved image file size.

80. The media of claim 75, wherein the metric is based on a difference between a target image quality and an achieved image quality.

81. The media of claim 73, wherein the one or more parameters are one or more of quantization parameters and truncation parameters.

82. The media of claim 81, wherein the quantization parameters are one or more of binwidths and quantization decisions.

83. The media of claim 81, wherein the truncation parameters are one or more of specific truncation points and truncation decisions.

84. The media of claim 73, wherein the first image and the next image are one or more of a sequence of images, time-series data, and 3-dimensional data sets.

85. The media of claim 73, further comprising information that iteratively controls the one or more parameters.

86. The media of claim 73, further comprising information that iteratively and dynamically controls the one or more parameters.

87. The media of claim 73, further comprising information that selects a binwidth.

88. The media of claim 73, further comprising information that selects a truncation.

89. The media of claim 73, further comprising information that selects a quantization.

90. An information storage media comprising information that compresses images comprising:
information that receives n images and compresses the n images at least based on one or more parameters; and
information that adapts the one or more parameters used on the n images, for use in compressing x images.

91. A storage media comprising information that has been compressed in accordance with a process comprising:
receiving n images and compressing the n images at least based on one or more parameters; and
adapting the one or more parameters used on the n images, for use in compressing x images.
